(19) United States
(12) Patent Application Publication
(10) Pub. No.: US 2024/0298754 A1
(43) Pub. Date: Sep. 12, 2024

(54) CONNECTION SYSTEM

(71) Applicant: Gottlieb Binder GmbH & Co. KG, Holzgerlingen (DE)

(72) Inventors: Lars Heepe, Tübingen (DE); Halvor Tramsen, Holzgerlingen (DE); Dirk-Michael Drotlef, Tiefenbronn (DE)

(73) Assignee: Gottlieb Binder GmbH & Co. KG, Holzgerlingen (DE)

(21) Appl. No.: 18/640,400

(22) Filed: Apr. 19, 2024

Related U.S. Application Data
(63) Continuation of application No. PCT/EP2022/078634, filed on Oct. 14, 2022.

(30) Foreign Application Priority Data
Nov. 4, 2021 (DE) 10 2021 005 460.1

(51) Int. Cl. A44B 18/00

(52) U.S. Cl. CPC A44B 18/0065; A44B 18/0057

(57) ABSTRACT

A connection system consists at least of an adhesion part and a fastening part. The adhesion part has at least one support part having a plurality of stem-like adhesion elements integrally joined thereto, the head parts of which adhesion elements can be releasably fixed at their free end faces to third components by means of adhesion. The fastening part is rigidly connected to the adhesion part on one side, and on another, opposite side has exposed fastening elements which, when brought into engagement with additional, correspondingly designed fastening elements of an additional fastening part, form a releasable adhesive fastener.

### CROSS-REFERENCE TO RELATED APPLICATIONS

This continuation application claims priority to PCT/EP2022/078634 filed on Oct. 14, 2022 which has published as WO 2023/078656 A1 and also the German application number DE 10 2021 005 460.1 filed on Nov. 4, 2021, the entire contents of which are fully incorporated herein with these references.

### FIELD OF THE INVENTION

The invention relates to a connection system using a fastening part and a closure part.

### BACKGROUND OF THE INVENTION

DE 10 2007 012 433 A1 relates to a fixing system or connection system, consisting of at least one fastening closure part that can be fixed with its fixing side to the free end face of a fixing part, the other active side of which is provided with an activatable active substance that, when activated, forms a fixing connection with the fixing side of a third-party component. The known system solution is used in particular as a laying system for carpets or carpet tiles with a carpet side forming the usable surface and a carpet backing forming the fixing side. This makes it possible to lay carpets or tiles in the usual solvent-free manner in closed rooms.

DE 10 2004 015 321 A1 discloses a connection system consisting at least of a fastening closure part with a carrier strip with interlocking elements arranged on one side thereof and with at least one cover strip, which forms at least one free side edge region that extends beyond the assignable longitudinal edge of the carrier strip, wherein the particular free side edge region of the particular cover strip can be folded over itself in the direction of the carrier strip along a fold line extending in the longitudinal direction in such a way that the end edge of the particular free side edge region of the cover strip is turned towards the assignable longitudinal edge of the carrier strip. As a further component of this connection system, a connection means for a molded foam is provided on the side, facing away from the interlocking elements, of the fastening closure part, which means is formed from a plurality of protruding individual rods that are held free of additional projections and connect to the molded foam. This creates a connection system for upholstered foam bodies that enables seat covers to be attached to them using a Velcro® fastening closure.

### SUMMARY OF THE INVENTION

The solutions in the prior art described above are not well suited for reversible fastening of functional components on uneven, wavy, and/or deformable surfaces.

Proceeding from this prior art, the invention is therefore based upon the object of creating a fastening solution that is improved in comparison and that also enables long-lasting, secure fastening of functional components to smooth surfaces, such as glass, but also for rough and wavy surfaces. A connection system of this type with the features of claim 1 achieves this object in its entirety.

The connection system according to the invention consists of at least: a fastening part that has at least one carrier part with a plurality of stem-like fastening elements connected thereto in one piece, the head parts of which can be fastened at their free end faces by means of adhesion to third-party components in a releasable manner; and a closure part that is firmly connected to the fastening part on one side and has exposed closure elements on another opposite side, which, when brought into engagement with further, correspondingly designed closure elements of a further closure part, form a releasable fastening closure.

The fastening part has a plurality of stem-like fastening elements, the widened ends of which can be releasably attached to third-party components, such as window glass, by means of adhesion to form head parts. The adhesion mechanism relies on so-called Van der Waals forces, which are relatively weak, non-covalent interactions between atoms or molecules; in view of the plurality of fastening elements—preferably more than 10,000 fastening elements per cm² of carrier surface of the carrier part—reliable adhesion of the fastening part as a whole to the third-party components, such as smooth surfaces, e.g., in the form of window glass, is nevertheless achieved. The connection system according to the invention can be designed as a film and, due to its flexibility, can conform to almost any substrate geometry as long as this is smooth at the nanoscopic level. In this respect, the connection system is also suitable for rough and wavy surfaces, such as those found on tiles or other textured components.

Another key component of the connection system is a closure part that is firmly connected to the fastening part and has a plurality of exposed closure elements—for example, in the form of a loop material. The closure part of this type with its closure elements forms a closure component that, together with a corresponding closure component, forms a traditional, permanently releasable fastening closure, which is also widely known as a “hook-and-loop fastener” or “Velcro® fastening closure.” The further closure component of the fastening closure constructed in this way is then connected to the particular functional component and enables the attachment of this functional component to the third-party component, regularly consisting of a smooth surface, such as glass, via the fastening closure connection and the fastening part. While the fastening part preferably remains on the specified third-party component, the functional component, via the removable fastening closure, can be removed from the closure part or the closure component that remains permanently on the fastening part as a component of the connection system.

This sequential structure of the fastening part with the closure part, in the context of the connection system, leads to an improved contact formation of the fastening closure to be realized on a surface of the third-party component with the resulting improved adhesive and shear properties for the fastening closure as a whole. In particular, this structure leads to improved adaptability of the adhesion to uneven surfaces and can compensate for unevenness existing to this extent both on the third-party component and, if applicable, on the functional component.

Due to the two-component structure of the connection system with the fastening part and the closure part as the one component, there is the possibility of an increase in the contact surface on the surface of the third-party component. For example, the fastening part of the one component can have a larger adhesion fastening surface than the other closure part, which is a component of the other closure component of the fastening closure to be produced. This increase in contact on the surface of the third-party component to be attached results in a higher adhesive and shear force for the overall connection system with the fastening closure, so that the functional component to be attached via the releasable fastening closure can have a correspondingly high weight force, which can still be securely fastened with the connection system.

The aforementioned increase in contact surface in conjunction with the two-component structure also brings a further advantage in terms of detachment behavior. Under very high loads or when opening the two-component system, it may be necessary to form a radially expanding and counter-running peel front, which requires a higher detachment force and thus significantly increases the resulting adhesion fastening force. In addition, the radially expanding peel front reduces the peel angle compared to known system solutions, and thus further increases the resulting adhesion fastening force.

The connection system as a whole has a higher adaptability compared to an adhesive elastomer layer according to the prior art, since the overall thickness of the connection system is greater, and thus unevenness inside and outside the connection system can be better compensated for to a greater extent. Even in direct comparison with an elastomer layer of the same thickness or a combination of such an elastomer layer with a soft-elastic layer, e.g., a layer made of foam, the adaptability and adhesion for the connection system according to the invention is improved, since the two-component system has no or only very greatly reduced restoring forces in the event of elastic deformation. Furthermore, the interlocking of the connection system with the additional closure component with the correspondingly designed closure elements as part of the releasable fastening closure reinforces the overall system created in this respect compared to a pure elastomer layer, with the result that any stresses or loads that may occur can be distributed over a larger area, thereby also improving the adhesive and shear properties.

In a particularly preferred embodiment of the connection system according to the invention, it is provided that the further closure part, on its side opposite the further closure elements, be able to be fastened to a functional component with a connecting means, such as an adhesive. Thus, a secure attachment of any type of functional component, e.g., in the form of a 5-G receiver in the context of a WLAN connection, to third-party components, such as a window glass surface in a building, is achieved, and, even if such relatively thin window glass panes deform due to weather influences, such as radiant heat or the like, the functional component remains securely fastened to the window glass of this type even over very long periods of use.

In a further particularly preferred embodiment of the connection system according to the invention, it can be provided that, between the fastening part and the closure part, at least one layer be inserted, at least one of which consists of a flexible and inelastic material, which is preferably a component, designed as a further carrier part, of the fastening part. In this way, any unevenness between the third-party component, e.g., in the form of the gas surface, and the connection system can still be compensated for and—particularly when using flexible and inelastic material—a more homogeneous stress/load distribution is achieved for the overall connection system, with the result that any stresses or loads that may occur can be distributed over a larger area, thereby also improving the adhesive and shear properties. It has been shown that a PET film between a closure material with adhesion properties, on the head side, based upon the Gecko principle and velour greatly increases the maximum adhesion force of the system through load sharing. This is indeed flexible and conforms very well to the surface to which it adheres. However, PET is not elastic, which is important for the load sharing of the system.

Both the connection system itself with the fastening part and the closure part, along with the additional closure part of the releasable fastening closure can be constructed in multiple layers, wherein the individual layers can comprise textiles, nets, films, magnetizable particles, elastomers, thermoplastic elastomers, metals, composites, polymers, adhesives, thermoplastics, or blends of these materials, also in conjunction with pure thermoplastics. These individual layers can be connected to one another in different ways—for example, glued or welded together. In particular, further layers with different functions can be applied to the upper side and/or lower side of the two components in question, the layers consisting for example of pressure-sensitive adhesives, contacts, magnets, integrated electronic components, or imprints, etc.

In particular, the fastening part, with its fastening elements, is formed from elastomers, thermoplastic elastomers, thermoplastics, or blends of these materials, also in conjunction with pure thermoplastics, wherein polysiloxanes, polyurethanes, natural rubbers, SBR, EPDM are particularly preferred.

In a further preferred embodiment of the connection system according to the invention, it is provided that the fastening part and the closure part consist of translucent plastic materials, which makes it possible to visually check the resulting contact formation. If, for example, the fastening part of the connection system is applied to a glass pane, and contact is established by lightly brushing over it by hand, regions in contact can be easily distinguished visually from regions that are not in contact with one another, which results from a difference in contrast within the framework of observation. If contrast differences of this type are detected, the full-surface contact formation can then be manually established afterwards and re-checked visually.

In a further preferred embodiment of the connection system according to the invention, it is provided that the fastening elements of the fastening part, arranged in groups, leave spaces between them, which lead to a visually recognizable segmentation. Preferably, it is provided that the closure elements of one closure part, arranged in groups, also leave spaces between them, which lead to a visually recognizable segmentation. The resulting individual segments can be realized at different distances and in different arrangements, so that a wide range of patterns can be generated.

It is also preferable that the spaces left free between the groups of fastening elements and/or closure elements be used to accommodate functional components, such as electronic components, magnets, imprints, etc. In this way, the connection system can also be equipped with information-carrying media for applications of all kinds.

In the context of a wide range of possible uses for the connection system, it is also preferably provided that the closure elements of the closure parts consist of hooks, double hooks, mushrooms, loops, stems, multifilaments, flocking fibers, etc., wherein the closure parts preferably are always selected in such a way that, in conjunction with one another, they form a fastening closure. Hermaphroditic connection systems can also be implemented, with which, for example, mushroom-to-mushroom connections form the particular releasable fastening closure.

### BRIEF DESCRIPTION OF THE DRAWINGS

The connection system according to the invention is explained in more detail below with reference to exemplary embodiments according to the drawing. In the drawings, which are schematic representations that are not to scale:

FIG. 1 shows a connection system according to the invention, consisting of a fastening part and a closure part, that forms a releasable fastening closure with a further closure part, wherein the connection system is fastened to a third-party component, such as a glass surface, and the further closure part is attached to a functional component that is to be fastened to the third-party component via the connection system;

FIG. 2 shows the connection system according to FIG. 1 with an additionally inserted layer—in particular, consisting of a flexible and inelastic material;

FIGS. 3 to 5 show a representation, corresponding to FIG. 2, of various embodiments of the connection system;

FIG. 6 shows a plan view of various structures for a segmented connection system in accordance with the representations according to FIGS. 1 to 7; and

FIG. 7 shows a schematically greatly simplified view of various closure elements that can be used for the corresponding closure parts to establish a fastening closure.

### DETAILED DESCRIPTION OF EMBODIMENTS OF THE INVENTION

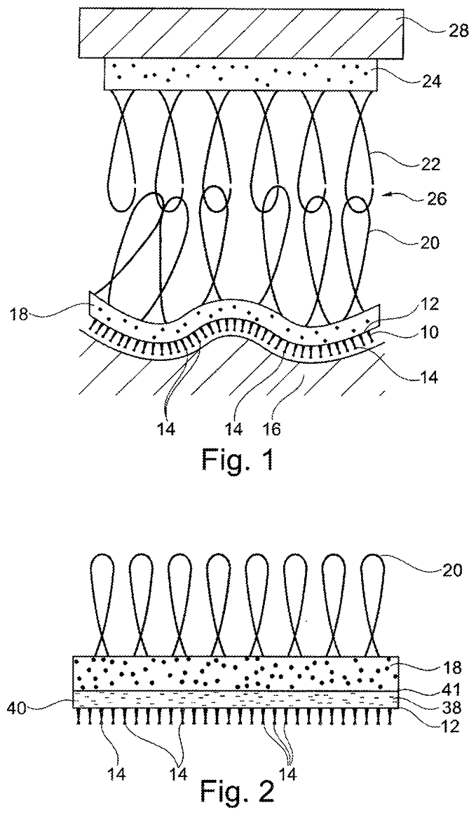

FIG. 1 shows the main components of the connection system in an operating or functional position. The connection system has a fastening part 10 that consists at least of one planar carrier part 12 with a plurality of stem-like fastening elements 14 connected thereto in one piece, the head parts of which can be fastened at their free end faces by means of adhesion to third-party components 16 in a releasable manner. DE 10 2004 012 067 A1 discloses a method for producing such fastening parts 10—also known as the chill-roll method. In accordance with the representation according to FIG. 1, the fastening part 10 is in direct adhering contact with the surface of the third-party component 16 as soon as the ends, on the head side, in the form of the head parts come into contact with this surface.

On the rear side of specified fastening part 10, there is a closure part 18 that is firmly connected to the fastening part 10 along an adjacent side, and, on the other, opposite side, there are exposed closure elements 20 that, when brought into engagement with further, correspondingly designed, hook-shaped closure elements 22 of a further closure part 24, form a releasable fastening closure 26. The rear side of the further closure part 24 is firmly connected to a functional component 28, which, like the third-party component 16, is shown only in section in FIG. 1; however, when the connection of the fastening closure 26 is established in accordance with the representation according to FIG. 1, it is fastened to the third-party component 26 via the fastening part 10.

A closure part 18 with loop-shaped closure elements 20 is shown by way of example in DE 102 40 986 B3. A base fabric of the closure part 18 consists of warp and weft threads, and, furthermore, at least one functional thread is partially woven into the base fabric as a so-called pile thread, which forms individual loops protruding over the base fabric as closure elements 20. If the loop-shaped pile threads formed in this way are cut laterally at their head end, individual closure hooks arise, which together form the hook-like closure element 22 for the further closure part 24. The interlocking of the closure part 18 with the other closure part 24 in the context of the fastening closure 26 does not have to be over the entire surface in order to achieve high adhesive and shear strengths; under certain circumstances, it can even be advantageous if the closure part 18 of the connection system adheres over the entire surface of strongly curved surfaces or beyond the edges of a surface, thus increasing the total contact surface for the connection system and also positively changing the detachment angle. Contrary to the wavy representation according to FIG. 1, the surface of the third-party component 16 can also extend parallel to the surface of the functional part 28. Furthermore, it is also possible to curve the surface of the functional component 28 or the functional component 28 itself, e.g., to provide it with a convex curvature, which is then followed by the further closure part 24 accordingly. Adhesion to surfaces remains even if the surface or the third-party component 16 continues to deform in the course of time. Since the interlocking is reversible and reconfigurable via the fastening closure 26, it can possibly loosen locally due to external deformations, but can also close again in a “self-healing” manner and follow the deformation accordingly. In this respect, the system works for partial and full-surface installation.

In addition to stiffening the overall system by combining two components, the overall system is additionally stiffened by firmly hooking the two components together. Here, one component is formed by the third-party component 16 with the described connection system including the fastening part 10 and the closure part 18, and the other, second component is formed by the functional component 28 in cooperation with the further closure part 24. Due to the additional stiffening of the entire system, any stresses that may occur at the interfaces are distributed more homogeneously over a larger area, and the adhesive and shear properties are further improved, which prevents failure of the intended connections in the context of the adhesion for the fastening part 10 and in the context of the hook-and-loop effect of the fastening closure 26 established.

As described above, the hook-and-loop fastening systems with the loop-shaped or hook-like closure elements 20, 22 can be both woven and knitted fabrics with the aforementioned pole elements. It is also possible to use nonwovens and film materials as the base substrate, which is provided with flocking fibers as the closure elements. Furthermore, a three-dimensional film manufactured in one piece can also be used as a carrier material for closure elements. In accordance with the representation according to FIG. 7, the pole elements can take various forms; for example, they can be in the form of loops 20 or hooks 22. Furthermore, the closure elements can be formed from double hooks 30 or consist of mushroom heads 32. Furthermore, individual stems 34 can also contribute to an effective adhesion to a limited extent. Multifilaments 36 in the form of multiple yarn systems can in turn form loops 20 or stems 34 in accordance with the representation according to FIG. 7. As utilized yarn and closure materials, various types of plastic materials can be used, including nylon or polypropylene materials.

The fastening part 10 consists of materials such as elastomers, thermoplastic elastomers, thermoplastics, or blends of these materials, with pure thermoplastics as well. The use of materials such as polysiloxanes, polyurethanes, natural rubbers, SBR, EPDM is particularly preferred. A conventional adhesive suitable for this purpose, e.g., a silicone-based adhesive, can be used to connect the fastening part 10 to the carrier part 12 of the closure part 18. The rear side of the additional closure part 24 can also be firmly connected to the opposite free end face of the functional component 28 using an adhesive of this type.

As the representation according to FIG. 2 shows, at least one further layer 38 can be inserted between the carrier part 12 and the closure part 18. Such a layer 38 and comparable layers can consist of textiles, nets, films, elastomers, thermoplastic elastomers, adhesives, thermoplastics, or blends of these materials, with pure thermoplastics as well, wherein PET, PE, HDPE, LDPE, PP, PVC, EPS, PUR are preferably used. The particular layer 38 can be bonded or welded to adjacent layers (not shown) and to the carrier part 12 and the closure part 18 in the usual manner. If the layer 38 in accordance with the representation according to FIG. 2 consists of a flexible, inelastic material, a further flexible, inelastic carrier part 40 is formed for the fastening part 10. In particular, if the flexible, inelastic layer 38 is formed from a PET film, this results in an improved stress/load distribution and adhesion for the overall connection system, and the fastening part 10 with its inelastic carrier parts 12, 40 and the fastening elements 14 then forms an inelastic or flexible component overall, which adheres particularly advantageously to the surface of the third-party component 16 and can be fixed there by means of adhesion. The fastening elements 14 form a microstructure that adheres to third-party components by means of adhesion on the head side, similar to the elements of a gecko foot, and which emerge directly from a silicone film. On the other side, there is a fleece/velour 18, which is provided with a base and adhesive. An additional film 41 is arranged between the layers 38 and 18, which film is non-elastic and flexible—for example, in the form of a PET film.

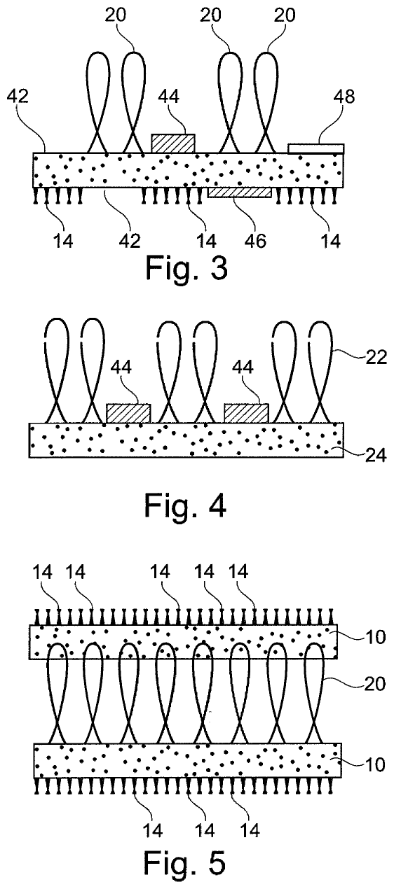

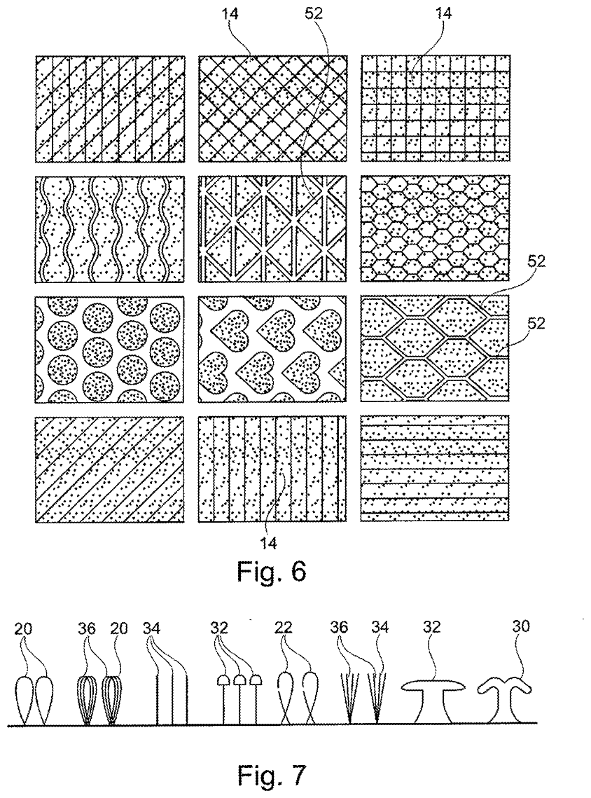

As can be seen further from the representation according to FIG. 3, both the fastening elements 14 and the loop-shaped closure elements 20 arranged in groups can leave spaces 42 between them, which lead to a visually recognizable segmentation, which is illustrated in FIG. 7, which in plan view shows different examples of a segmentation, seen both in plan view of the fastening elements 14 and, alternatively, in plan view of the opposite side, the individual loops 20 for the closure part 18 of this type. In this way, any design requirements of the market are met within a broad framework.

The spaces 42 left free shown in FIG. 3 between the groups of fastening elements 14 can be used to accommodate functional components, such as electronic components 44—for example, in the form of computer chips. A further possibility consists of the accommodation of magnets 46, which can improve the connection of a further closure part, which, for example, has ferromagnetic components in its carrier component. Another non-exhaustive possibility consists of providing such a space 42 left free for the application of imprints 48 that, in addition to the usual design aspects, can also ensure the recognizability of the product.

In accordance with the representation according to FIG. 4, the functional components described above can also be used between the hook-like closure elements 22 of the further closure part 24, which are arranged in groups and leave spaces 42 between them.

With the solution according to FIG. 5, the lower structure, as seen in the direction of FIG. 5, with the fastening part 10 lying above it, is inserted in a quasi-mirror image along the upper side of the loop-shaped closure elements 20 into the respective ends of the loops. In this way, the fastening part 10 as a whole is redundantly designed and now, via the upper fastening elements 14, enables the possibility of forming additional connections, whether it be with functional components including associated surfaces, or in the form of carriers with correspondingly designed closure elements (not shown), which can interact with the above-mentioned protruding fastening elements 14 to form a fastening closure.

What is claimed is:

1. A connection system, consisting essentially of:
a fastening part that has at least one carrier part with a plurality of stem-like fastening elements connected thereto in one piece, wherein a head part of each of the plurality of stem-like fastening elements are configured to be fastened at their free end faces by means of adhesion to third-party components in a releasable manner; and
a closure part that is firmly connected to the fastening part on an opposite side to the plurality of stem-like fastening elements, the closure part having closure elements, which, when brought into engagement with further, correspondingly designed closure elements of a further closure part, form a releasable fastening closure.

2. The connection system according to claim 1, wherein the further closure part, on its side opposite the further closure elements, is configured to be fastened to a functional component with a connecting means.

3. The connection system according to claim 2, wherein the connecting means is an adhesive.

4. The connection system according to claim 1, wherein, between the fastening part and the closure part, at least one layer can be inserted, at least one of which consists of a flexible, inelastic material, which is a component, designed as a further carrier part, of the fastening part.

5. The connection system according to claim 2, wherein, between the fastening part and the closure part, at least one layer can be inserted, at least one of which consists of a flexible, inelastic material, which is a component, designed as a further carrier part, of the fastening part.

6. The connection system according to claim 1, wherein the fastening part with its components, for adhering to curved surfaces of the associated third-party component, is designed as a flexible component.

7. The connection system according to claim 1, wherein the fastening part and the closure part consist of translucent plastic materials.

8. The connection system according to claim 1, wherein the fastening elements of the fastening part, arranged in groups, leave spaces between them, which lead to a visually recognizable segmentation.

9. The connection system according to claim 1, wherein the spaces left free between the groups of fastening elements are used to accommodate functional components, such as electronic components, magnets, and imprints.

10. The connection system according to claim 1, wherein the closure elements of at least one closure part, arranged in groups, leave spaces between them, which lead to a visually recognizable segmentation.

11. The connection system according to claim 1, wherein the spaces left free between the groups of closure elements are used to accommodate functional components, such as electronic components, magnets, and imprints.

12. The connection system according to claim 1, wherein the closure elements of the closure parts optionally consist of hooks, double hooks, mushrooms, loops, stems, multifilaments, and flocking fibers.
